(19) United States
(12) Patent Application Publication
(10) Pub. No.: US 2010/0213008 A1
(43) Pub. Date: Aug. 26, 2010

(54) Fixation-Arrangement

(76) Inventor: Ringo Haenisch, Brande (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/703,340

(22) Filed: Feb. 10, 2010

(30) Foreign Application Priority Data
Feb. 23, 2009 (EP) 09002567.7

(51) Int. Cl. E06C 7/18; E06C 7/50

(52) U.S. Cl. 182/129

(57) ABSTRACT

An arrangement for a fixation, which is applied to a ladder is provided. The ladder includes at least one hollow rung. A bolt is located longitudinally and inside the hollow rung. The bolt includes at its first side an eye, which is used as attachment-point for attachment-purposes, while the eye is located outside the hollow rung on a first side of the ladder. The bolt includes at its second side an interlock, which can be engaged at a second side of the ladder firmly but detachably, so a movable attachment-point is originated at the ladder by the hollow-rung, by the inserted bolt and by the eye and the interlock, which are connected with the bolt.

### CROSS REFERENCE TO RELATED APPLICATIONS

This application claims priority of European Patent Office application No. 09002567.7 EP filed Feb. 23, 2009, which is incorporated by reference herein in its entirety.

### FIELD OF INVENTION

The invention relates to an arrangement for a fixation, which is dedicated to be used for a fall arrest in a preferred embodiment.

### BACKGROUND OF INVENTION

Within a nacelle of a wind-turbine or within a tower a number of anchor-points for the fixation of fall arrest are needed for service purposes.

An anchor point typically comprises an eye bolt, which is formed to support ropes or other attachments used for fall arrest purposes, for example for the fixation of a personal harness.

The eye bolt is normally fixed in position, connected for example with a tower wall or a component in a nacelle.

When designing a tower or a wind-turbine a number of anchor points are placed in a strategic way, but their number is normally not sufficient to cover all possible situations.

For this reason ladder steps or rungs might be used partly to provide additional anchor points, for example for the fixation of fall-arrest-ropes, work-positioning-ropes, cables, etc.

Since ladder steps are typically not dimensioned adequately for the forces that might arise as a result of the fall of a human body, technicians are normally instructed to use dedicated, selected points on a ladder for their fixation-purposes. A typical point for fixation may be located near the top of the ladder as this end is secured by bolts and brackets at the (tower-)wall.

Because of the bolt and brackets these position is stable enough for a planned fixation.

Tests have shown that even with M16 bolt reinforcements the load capacity of the ladder is limited.

Another problem is that the strength of the rungs of the ladder has to be sufficient enough to withstand an impact, occurring from a fall.

A damaged ladder has to be replaced, but this task is not easy, as the ladder is normally long and a remaining space inside the tower, which has to be used for the replacement, is often too small—because of already mounted components like cables, guiding-equipment, electronic-equipment, etc.

### SUMMARY OF INVENTION

It is therefore the aim of the invention, to provide an improved fixation-arrangement to be used in combination with a ladder preferably.

This aim is solved by the features of independent claims. Preferred embodiments of the invention are subject of the dependent claims.

According to the invention the fixation-arrangement comprises a ladder with rungs. The ladder shows at least one hollow rung. A bolt is located longitudinally and inside the hollow rung. The bolt shows at its first side an eye, which is used as attachment-point for attachment-purposes, while the eye is located outside the hollow rung on a first side of the ladder. The bolt shows at its second side an interlock, which can be engaged at a second side of the ladder firmly but detachably. Therefore a movable attachment-point is originated at the ladder by the hollow-rung, by the inserted bolt and by the eye and the interlock, which are connected with the bolt.

The eye is dedicated to be used for attachment-purposes—for example to carry a rope, a fall-arrest lanyard, a fall-restraint lanyard, cables, etc.

In a preferred embodiment the first side of the bolt comprises a stopper, which prevents that the eye can be inserted into the hollow rung.

In a preferred embodiment the interlock is dimensioned in a way that it can be inserted into the hollow rung. Accordingly the bolt is inserted by its second side into the hollow rung until the stopper adjoins a first side of the ladder—so the insertion is stopped.

In an improved embodiment the eye itself is big enough to act as stopper—preferably its diameter is bigger than the diameter of the hollow rung.

In an improved embodiment the bolt is longer than the rung, so the whole rung is penetrated longitudinally. Because of the length of the bolt the interlock is located outside the hollow rung when the insertion is stopped by the stopper.

The interlock is designed in a way that it can be engaged at a second side of the ladder in a firmly but detachably manner. Therefore a movable attachment-point is originated at the ladder.

By help of the stopper and of the interlock the bolt is fixed inside the rung, while the rung is enforced additionally by the bolt.

The inventive arrangement allows the application of movable anchor points along the ladder at any rung-position in a very easy manner.

The inserted bolt enforces the rung—so forces, which arise due to a fall of a human body, can be absorbed by the enforced rung.

The inventive arrangement also allows the removal of unused anchor points fast and very easily.

The inventive arrangement can be installed at old and new ladders very easily, as long as the ladder comprises hollow rungs.

The parts of the inventive fixation can be transported very easily inside the tower or wind-turbine and also to and from the site of the tower or wind-turbine.

Additionally the inventive fixation is very cheap.

### BRIEF DESCRIPTION OF THE DRAWINGS

The invention will be shown in more detail by help of drawings.

FIG. 1 shows a first embodiment to be used as part of the fixation-arrangement according to the invention,

FIG. 2 shows a second embodiment to be used to be used as part of the fixation-arrangement according to the invention, and

FIG. 3 shows the fixation-arrangement with both embodiments as described above in FIG. 1 and FIG. 2.

### DETAILED DESCRIPTION OF INVENTION

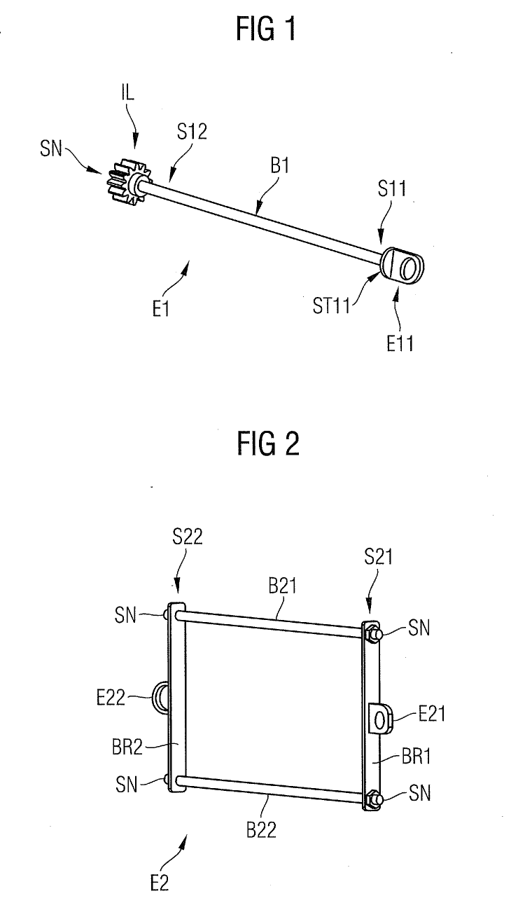

FIG. 1 shows a first embodiment E1 to be used as part of the fixation-arrangement according to the invention.

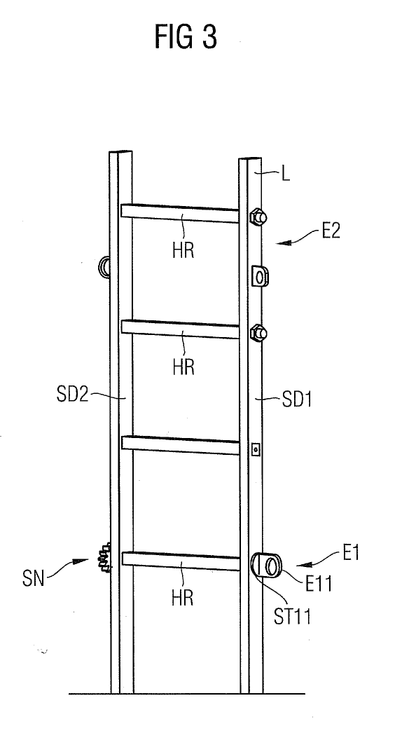

A bolt B1 is dedicated to be inserted into a hollow rung of a ladder as described later in FIG. 3.

The bolt B1 comprises on its first side S11 an eye E11 for attachment-purposes.

The bolt B1 also comprises at its first side S11 a stopper ST11, which is formed as a flange for example and which prevents, that the eye E11 can be inserted into the hollow rung as described later.

The bolt B1 comprises at its second side S12 an interlock IL. In this case the interlock IL comprises a thread to carry a screw-nut SN.

In a preferred embodiment a thread-rod is used as bolt B1.

The interlock IL is dimensioned in a way, that the interlock IL can be inserted into a hollow rung of a ladder as described later.

Because of the thread and the screw-nuts the embodiment E1 can be engaged very easily at the ladder, in a firm but detachably manner.

FIG. 2 shows a second embodiment E2 to be used as part of the fixation-arrangement according to the invention.

A bolt B21 and a bolt B22 are dedicated to be inserted into hollow rungs of a ladder as described later in FIG. 3.

Both bolts B21, B22 show threads on their first sides S21 and on their second sides S22, too.

A first bar BR1 comprises a first eye E21, while a second bar BR2 comprises a second eye E22.

The first bar BR1 is connected via screw-nuts SN with the first sides S21 of the bolts B21, B22.

Accordingly the second bar BR2 is connected via screw-nuts SN with the second sides S22 of the bolts B21, B22.

Compared with FIG. 1 the functionality of the “stopper” is performed by the first bar BR1.

The functionality of the “interlock” is built by the second bar BR2, the thread on the second side S22 of the bolts B21, B22 and by the screw-nuts SN, connected at the second side S22 of the bolts B21, B22.

In a preferred embodiment thread-rods are used as bolts B21, B22.

Because of the threads and the screw-nuts the embodiment E2 can be engaged very easily at the ladder, in a firm but detachably manner.

FIG. 3 shows the fixation-arrangement with both embodiments E1, E2 as described above in FIG. 1 and FIG. 2.

A ladder L shows for example three hollow rungs HR.

One hollow rung HR is needed to carry the embodiment E1 as described above, while two other hollow rungs are used to carry the embodiment E2 as described above.

Referring to FIG. 1 and to the embodiment E1, the bolt B1 is inserted (without the screw-nut SN) via its second side S12 into the hollow rung HR until the stopper ST11 adjoins a first side SD1 of the ladder L, so the insertion is stopped.

The bolt B1 is located into the hollow rung HR, so it penetrates the hollow rung HR longitudinally.

The bolt B1 is longer than the hollow rung HR. Therefore the interlock IL is allowed to be outside of the hollow rung HR when the insertion is stopped.

The interlock IL is now engaged by the screw-nut SN on a second side SD2 of the ladder L.

This embodiment allows to be tightened and to be released without tools due to the large grip of the components.

Due to the small size this “mobile anchor point assembly” can be attached to a belt of a person, while he is climbing up and down the ladder.

Referring to FIG. 2 and to the embodiment E2, the bolts B21, B22 are inserted (without the screw-nuts SN and the bar second BR2) via its second side S22 into the hollow rung HR until the first bar BR1, used as stopper in this example, adjoins the first side SD1 of the ladder, so the insertion is stopped.

The bolts B21 and B22 are located into the hollow rungs HR, so they penetrate the hollow rungs HR longitudinally.

The bolts B21, B22 are longer than the hollow rungs HR, so the threads, used for the interlock, are allowed to be outside the hollow rungs HR when the insertion is stopped.

The interlock is now engaged by the screw-nuts SN and by the second bar BR2 on the second side SD2 of the ladder L.

The embodiment E2 allows to distribute loads, acting on the eye E21 and/or the eye E22, over two rungs of the ladder.

It is also possible to attach snap-hooks of fall-arrest and fall-restraint lanyards to the eyes E21, E22.

This embodiment is also well-suited to assist cable works, etc.

1.-10. (canceled)

11. A fixation-arrangement, comprising:
a ladder comprising:
a hollow rung,
a first side, and
a second side;
a bolt comprising:
a first side including an eye to be used as an attachment-point for attachment-purposes, and
a second side including an interlock,
the bolt is arranged longitudinally inside the hollow rung such that the eye is located outside the hallow rung on the first side of the ladder,
the interlock thinly but detachably engaged at a second side of the ladder, and
the attachment-point is movable and originated at the ladder by the hollow-rung, by the inserted bolt and by the eye and the interlock, which are connected with the bolt.

12. The arrangement according to claim 11, wherein
the bolt comprises at its first side a stopper, which prevents the eye from being inserted into the hollow rung,
the interlock is dimensioned to allow the interlock to be inserted into the hollow rung,
the second side of the bolt is inserted into the hollow rung until the stopper adjoins the first side of the ladder whereby the insertion is stopped, and
the bolt is longer than the hollow rung, so the interlock is located outside the hollow rung when the insertion is stopped.

13. The arrangement according to claim 11, wherein
the eye is built to support a rope, a fall-arrest lanyard or a fall-restraint lanyard.

14. The arrangement according to claim 11, wherein
the eye itself is dimensioned to be used as stopper.

15. The arrangement according to claim 11, wherein
the interlock comprises a thread to attach a screw-nut, and
the screw-nut is acting against the second side of the ladder, so the interlock is engaged.

16. The arrangement according to claim 11, wherein
the interlock includes an eye for attachment purposes.

17. A fixation-arrangement, comprising:
a ladder comprising:
a first hollow rung,
a second hollow rung,
a first side, and
a second side;
a first bolt arranged longitudinally inside the first hollow rung;
a second bolt arranged longitudinally inside the second hollow rung; and
a first bar comprising an eye to be used as an attachment-point for attachment-purposes,
the first bar arranged at the first side of the ladder and is connected to first and second bolts, and
the first and second bolts are each engaged on the second side of the ladder by an interlock.

18. The arrangement according to claim 17, further comprises:
a second bar arranged at the second side of the ladder,
the second bar is connected with the first and second bolts on the second side of the ladder, to be used as part of the interlock.

19. The arrangement according to claim 18, further comprises:
the second bar comprises an eye for attachment purposes.

20. The arrangement according to claim 17, wherein
the second bar is connected with the first and second bolts by screw-nuts.

21. A movable fixation device, comprising:
a bolt for inserting into a hallow rung of a first side of a ladder, the bolt comprising:
a first side including an eye to be used as an attachment-point for attachment-purposes, and
a second side including an interlock for firmly attaching to a second side of the ladder.

22. The device according to claim 21, wherein
the bolt comprises at its first side a stopper for preventing the eye from being inserted into the hollow rung.

23. The device according to claim 21, wherein
the eye is built to support a rope, a fall-arrest lanyard or a fall-restraint lanyard.

24. The device according to claim 21, wherein
the eye itself is dimensioned to be used as stopper.

25. The device according to claim 21, wherein
the interlock comprises a thread to attach a screw-nut, and
the screw-nut is acting against the second side of the ladder, so the interlock is engaged.

26. The device according to claim 21, wherein
the interlock includes an eye for attachment purposes.
